(19) United States
(12) Patent Application Publication
(10) Pub. No.: US 2011/0248227 A1
(43) Pub. Date: Oct. 13, 2011

(54) PROTECTION FOR A BUCKLING DETECTION HEAD

(75) Inventors: Gerard Plumettaz, Territet - Veytaux (CH); Andreas Breit, Gmund (AT)

(73) Assignee: PLUMETTAZ SA, Bex (CH)

(21) Appl. No.: 13/058,538

(22) PCT Filed: Aug. 19, 2009
(86) PCT No.: PCT/EP2009/060713

§ 371 Date: Jun. 28, 2011

(30) Foreign Application Priority Data
Aug. 21, 2008 (CH) 1324/08

(51) Int. Cl. H02G 1/08

(52) U.S. Cl. 254/134.4

(57) ABSTRACT

The buckling detection head is completely encapsulated in an encapsulating material, thus making it possible to protect the emitting and receiving surfaces of the cells for emitting and receiving light signals. This arrangement provides a slot in which the absolutely smooth cable passes, making it easier to clean the head and protect the cells. Other advantages of this arrangement are also described.

The present invention relates to the field of fibre optic cable laying in a tube, in particular cable introduction devices in the tube, comprising mechanical cable thrust means as well as blowing means of a gaseous or liquid fluid under pressure for transporting the cable in the tube, said introduction device comprising a cable buckling-detection device, the invention particularly relating to the mechanical protection of this detection device.

The patent by British Telecommunications Public Limited Company (GB) EP 015 928 describes in detail an introduction device for a cable or fibre optics in a tube. This device comprises a mechanical thrust device constituted by a drive wheel and a support wheel, a device for blowing pressurised air in the tube for transporting the fibre optic in the tube as well as a buckling-detection device of the fibre during cable laying, this buckling originating from a positive difference between the thrust force exerted by the mechanical thrust device and the friction resistance force of the fibre in the tube. Such buckling during cable laying is to be avoided to retain the transmission qualities of the fibre. The patent cited completely describes such an introduction device, its operation and the electronic means for re-establishing optimum laying conditions of the fibre after buckling has been detected by the detection device.

The buckling-detection device described in the above patent comprises a deep slot in which the fibre is guided, capable especially of assuming two predetermined positions, a first position of normal laying, without buckling, and a second position with slight buckling insufficient to destroy the transmission qualities of the fibre. Each of these positions is detected by a set of emitting cells and receiving cells of a light beam, the presence or absence of the beam on the receiving cell of each of said sets indicating a correct position of the fibre or detecting tendency to buckle.

The above patent shows that each of these emitting and receiving cells is a discrete element, mounted individually in a housing which corresponds to it in a support to form the buckling-detection head.

Given that a cable introduction device is generally intended for use on a cable-laying work site and not just in the laboratory, that is, it must be suitable for operating in a humid and/or dusty atmosphere, and for receiving mud spatter, such an arrangement of the emitting and receiving cells involves numerous disadvantages.

During use, the cells being placed in positioning slots having rough protuberances and dust can be deposited in these slots, rapidly fouling the system.

The cable can transport dust or other abrasive elements likely to scratch one or more of the emitting or receiving surfaces of the cells.

Cleaning the emitting and receiving surfaces of the cells can prove difficult, as each surface has to be cleaned individually, this cleaning potentially destroying the emitting or receiving surface by abrasion by dust during cleaning; this cleaning is also likely to upset the position of the cell during cleaning.

Replacing a damaged cell can prove complicated, especially for fitting the connecting feet of the cell at the work site; after exchange of the cell, its position has to be adjusted.

The aim of the present invention is to propose protecting the buckling-detection head, comprising the emitting and receiving cells, to avoid the abovementioned disadvantages of known buckling-detection heads.

For this, the optic cable introduction device comprises a buckling-detection head, such as described in Claim 1. Variant embodiments are described in the dependent claims.

The invention is described more precisely hereinbelow, with this description considered with respect to the attached diagram comprising the figures where:

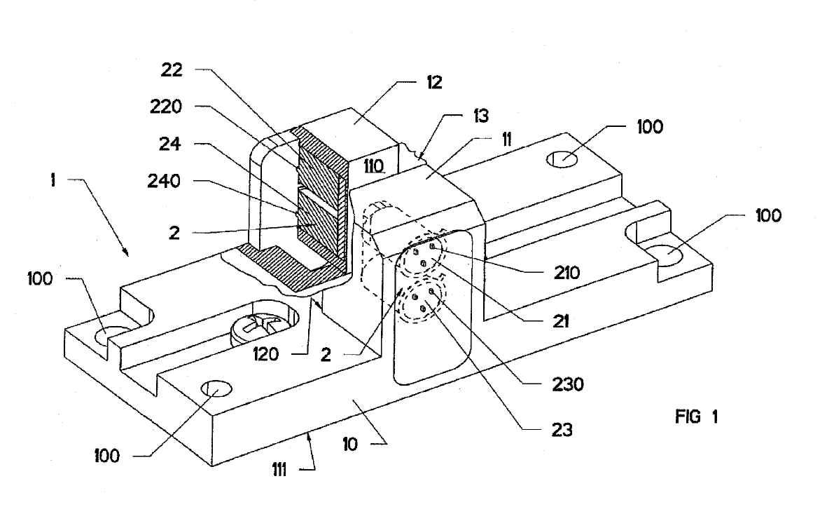

FIG. 1 is a top plan view in perspective with partial section of a buckling-detection head according to the invention, and

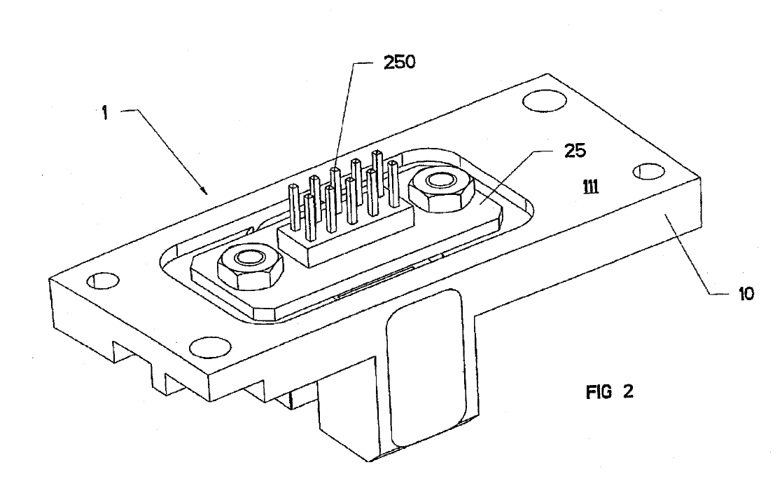

FIG. 2 is a bottom plan view of the same buckling-detection head.

The buckling-detection head 1 illustrated in FIG. 1 comprises a base plate 10 to be fixed on a portion of the cable introduction device, for example by fixing screws passing through the holes 100. The cable introduction device and the fixing screws are not illustrated in the figures. The base plate 10 is surmounted by two detection blocks 11 and 12, arranged projecting perpendicularly on the upper surface of the base plate 10, the two detection blocks being separated by the slot 13 in which the cable circulates. The slot 13 is limited by the two surfaces 110 and 120 facing each of the detection blocks 11 and 12. The width of the slot 13, respectively the spacing between the two surfaces 110 and 120, is slightly larger than the maximum cable diameter likely to be laid using this introduction device.

Buckling is detected by two sets 2 of emitting and reception cells of light beams illustrated at 21, 22 and 23, 24. The set of cells 21, 22 detects the presence of the cable being laid as it circulates in the top position of the slot 13, while the set of cells 23, 24 detects a position of light buckling of the cable while this buckling pushes it into the low position of the slot 13.

The whole device, base plate 10 and detection blocks 11 and 12 is produced by casting synthetic material, for example resin, about the electronic components 21, 22, 23 and 24. The assembly therefore makes up a rigid and undeformable element. The synthetic material used can be any type suitable for this usage, with the restriction that at least the faces 110 and 120 limiting the slot 13, or at least the portions of these faces directly opposite the cells 21, 22, 23 and 24 are translucid so as to allow passage of light beams between said cells.

It is evident that the faces 110 and 120 exhibit no roughness, are absolutely smooth and can therefore be cleaned very easily. The emitting and receiving surfaces of the cells 21, 22, 23 and 24 are protected by a layer of the encapsulating material and can therefore no longer be fouled or damaged. As the relative positions of the cells 21, 22, 23 and 24 is fixed during coating of said cells by the coating material, these positions can no longer be misplaced.

FIG. 1 also shows the electric connecting feet 210, 220, 230 and 240 of the cells 21, 22, 23 and 24. These feet are welded to connecting wires, not illustrated in the figures, these wires emerging from the device via the lower face 111 of the base plate 10.

With reference to FIG. 2, this shows a connector 25 bearing a plurality of contact rods 250, this connector being fixed for example by way of screws to the lower face 111 of the base plate 10 of the device. Each of the connecting wires mentioned above is therefore attached by welding or any other connection means to the contact rod 250 corresponding to the latter.

Therefore, because the electric link of the cells 21, 22, 23 and 24 is done in the factory, operating failure of one of the cells 21, 22, 23 or 24 no longer involves a delicate welding operation to be undertaken at the work site.

As a variant embodiment, it is more than possible to install the cells 21, 22, 23 and 24 on the connector 25 prior to completing the coating operation, the connector 25 forming an integral part of the detection head 1.

Given that it becomes very easy to install a detection head 1 on a cable introduction device via the screws placed in the holes 100, the electric link between the detection head and since the cable introduction device is ensured via the connector 25, 250 and a corresponding female connector arranged on the cable introduction device, provision can be made to have several such detection heads, each having a slot width 13 adapted to the diameter of the cable to be laid.

It is noted therefore that a buckling-detection head, provided to be installed on a cable introduction device such as described hereinabove completely satisfies the fixed requirements, making cleaning easy, making it impossible to damage the emitting or receiving cells, the position of said tamperproof cells, making exchanging the measuring head easy, these diverse advantages making easy work for operators at a cable-laying work site.

1. A buckling-detection head intended to be installed on a fibre optic cable-laying device in a tube, said laying device comprising especially mechanical thrust means of said cable and blowing means of gaseous or liquid fluid under pressure, the detection head comprising a slot, a first set of emitting and receiving cells of a light signal arranged on a first upper portion of said slot and signalling the presence of a cable being laid, a second set of emitting and receiving cells of another light signal arranged on a second lower portion of said slot and signalling buckling of the cable being laid, wherein the cells are encapsulated in a coating product, forming two rigid detection blocks arranged on either side of the slot, at least portions of the surfaces of the two blocks limiting the slot placed face to face to the emitting and receiving surfaces of the cells being translucid.

2. The detection head as claimed in claim 1, wherein the surfaces of the two blocks limiting the slot are completely translucid.

3. The detection head as claimed in claim 1, wherein the surfaces of the two blocks limiting the slot are completely smooth.

4. The detection head as claimed in claim 1, wherein the electric connecting feet of the cells are connected to a connector.

5. The detection head as claimed in claim 4, wherein the connector is fixed on the lower face of the detection head.

6. The detection head as claimed in claim 4, wherein the connector is encapsulated simultaneously with the cells.

7. The detection head as claimed in claim 1, wherein the width of the slot, respectively the distance separating the two surfaces, is adapted to the diameter of the cable to be laid, as it is larger than this diameter.

8. A cable-laying device comprising especially mechanical thrust means of said cable and pressurised air blowing means, characterised in that it comprises a buckling-detection head as claimed in claim 1.
